(19) United States
(12) Patent Application Publication
(10) Pub. No.: US 2026/0042902 A1
(43) Pub. Date: Feb. 12, 2026

(54) RUBBER COMPOSITION AND POWER STEERING HOSE

(71) Applicant: THE YOKOHAMA RUBBER CO., LTD., HIRATSUKA-SHI (JP)

(72) Inventor: Koki SUGIHARA, HIRATSUKA-SHI (JP)

(21) Appl. No.: 19/262,825

(22) Filed: Jul. 8, 2025

(30) Foreign Application Priority Data
Aug. 9, 2024 (JP) 2024-133997

(51) Int. Cl. C08K 5/3445; B62D 5/06; C08K 3/04; C08K 5/14

(52) U.S. Cl. CPC C08K 5/3445; C08K 3/04; C08K 5/14; B62D 5/062

(57) ABSTRACT

A rubber composition containing a rubber component containing 60 mass % or more of a hydrogenated acrylonitrile butadiene rubber, a compound represented by General Formula (1), carbon black, and a peroxide, and a power steering hose produced by using the rubber composition. The rubber composition can provide elongation at break and modulus in a compatible manner at an excellent level when a cured article is formed, and a power steering hose.

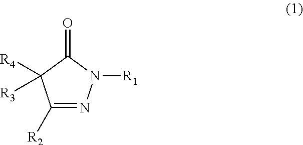

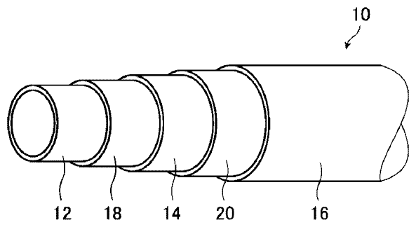

### TECHNICAL FIELD

The present invention relates to a rubber composition and a power steering hose.

### BACKGROUND ART

Typically, an automobile uses a hose for power steering.

Meanwhile, a rubber composition for a hose and a hose with excellent oil resistance and low-temperature performance have been proposed (e.g., Patent Document 1).

### CITATION LIST

### Patent Literature

Patent Document 1: JP 2022-131899 A

### SUMMARY OF INVENTION

### Technical Problem

Because a power steering hose for an automobile undergoes hose stretching due to internal pressure (oil pressure), excellent toughness against internal pressure is required for a power steering hose (especially, an inner tube of the power steering hose). To achieve excellent toughness against internal pressure, a high elongation at break is required for a power steering hose.

Furthermore, a power steering hose is typically connected to a pipe made of a metal, and metal parts for joint are further equipped at both terminals of the power steering hose. Thus, a high modulus is also required for the power steering hose to achieve excellent sealing properties by swaging by the metal parts described above used for connecting the power steering hose and a metal pipe (hereinafter, the sealing properties by swaging are also referred to as “sealing properties with the metal parts”).

To improve elongation at break required for achieving excellent toughness against internal pressure, techniques such as reducing crosslinking density and reducing an amount of fillers exist; however, these techniques lead to reduction in the modulus.

As described above, in a power steering hose, the elongation at break and the modulus are in an antinomic relationship and are extremely difficult to be provided in a compatible manner.

An object of the present invention is to provide a rubber composition that can provide elongation at break and modulus in a compatible manner at an excellent level when a cured article is formed.

Another object of the present invention is to provide a power steering hose that can provide elongation at break and modulus in a compatible manner at an excellent level.

### Solution to Problem

As a result of diligent research to solve the issues described above, the inventor of the present invention found that the desired effects can be achieved by a rubber composition containing a rubber component containing 60 mass % or more of hydrogenated acrylonitrile butadiene rubber, a compound having a specific structure, carbon black, and a peroxide.

That is, specifically, the present invention is to solve the issues described above by the following configurations.
[1] A rubber composition containing:
a rubber component containing 60 mass % or more of a hydrogenated acrylonitrile butadiene rubber;
a compound represented by General Formula (1) below;
carbon black; and
a peroxide.

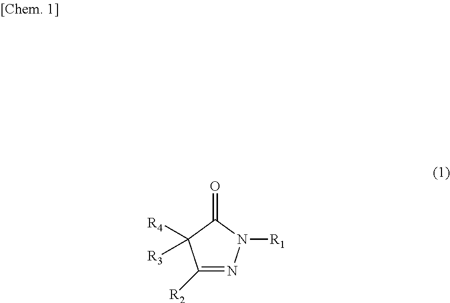

In General Formula (1), R₁, R₂, R₃, and R₄ are the same or different and each represent a hydrogen atom, an alkyl group, an aralkyl group, an aryl group, or a heterocyclic group. R₃ and R₄ may together form an alkylidene group, and any two of R₂, R₃, and R₄ may together form an alkylene group. Each of these groups may have one or more substituents.
[2] The rubber composition according to [1], in which a content of the compound represented by General Formula (1) is from 0.3 to 2.0 parts by mass per 100 parts by mass of the rubber component.
[3] The rubber composition according to [1] or [2], in which the carbon black include one type or a plurality of types of carbon black having a nitrogen adsorption specific surface area of less than 60 m²/g.
[4] The rubber composition according to any one of [1] to [3], in which a content of the peroxide is from 1.6 to 4.0 parts by mass per 100 parts by mass of the rubber component.
[5] The rubber composition according to any one of [1] to [4], in which substantially no sulfur is contained.
[6] The rubber composition according to any one of [1] to [5], in which the rubber composition is for a hose.
[7] A power steering hose produced by using the rubber composition according to any one of [1] to [6].
[8] The power steering hose according to [7], including an inner tube containing the rubber composition.

### Advantageous Effects of Invention

The present invention can provide a rubber composition that can provide elongation at break and modulus in a compatible manner at an excellent level when a cured article is formed.

In addition, the present invention can provide a power steering hose.

### BRIEF DESCRIPTION OF DRAWINGS

The single drawing Figure is a schematic perspective view illustrating an example of a power steering hose of an embodiment of the present invention with layers partially cut away.

### DESCRIPTION OF EMBODIMENTS

The present invention is described in detail below.

Although the components described below may be described based on representative embodiments of the present invention, the present invention is not limited to such embodiments.

In the present description, a numerical range indicated using “(from) . . . to . . . ” includes the former number as the lower limit value and the latter number as the upper limit value.

In the present description, each component can use a single component alone, or a combination of two or more types.

In the present description, in a case where a component uses a combination of two or more types, a “content” of the component means a total content of these two or more types unless otherwise noted.

In the present description, the production method of each component is not particularly limited unless otherwise noted. Examples of the method include a known method.

In the present description, elongation at break when a cured article is formed may be simply referred to as “elongation at break”. The modulus when a cured article is formed may be simply referred to as “modulus”.

In the present description, when a cured article is formed, achieving elongation at break and modulus in a compatible manner at an excellent level may be referred to as “achieving superior effects of an embodiment of the present invention”.

### Rubber Composition of Present Invention

The rubber composition according to an embodiment of the present invention is described below.

The rubber composition of an embodiment of the present invention is
a rubber composition containing:
a rubber component containing 60 mass % or more of a hydrogenated acrylonitrile butadiene rubber;
a compound represented by General Formula (1) below;
carbon black; and
a peroxide.

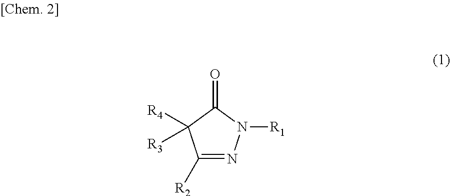

In General Formula (1), R₁, R₂, R₃, and R₄ are the same or different and each represent a hydrogen atom, an alkyl group, an aralkyl group, an aryl group, or a heterocyclic group. R₃ and R₄ may together form an alkylidene group, and any two of R₂, R₃, and R₄ may together form an alkylene group. Each of these groups may have one or more substituents.

### Rubber Component

The rubber composition of an embodiment of the present invention contains a rubber component containing 60 mass % or more of a hydrogenated acrylonitrile butadiene rubber.

### Hydrogenated Acrylonitrile Butadiene Rubber

In an embodiment of the present invention, the rubber component contains a hydrogenated acrylonitrile butadiene rubber. In the present description, a hydrogenated acrylonitrile butadiene rubber is also referred to as a “HNBR”.

The HNBR contained in the rubber composition of an embodiment of the present invention is a hydrogenated product of a copolymer of acrylonitrile and butadiene.

The HNBR has an acrylonitrile group.

The hydrogenation of the HNBR is a hydrogenation in a main chain, and the hydrogenation may be partial hydrogenation or full hydrogenation.

### Acrylonitrile Amount

The acrylonitrile amount (AN amount) of the HNBR is preferably from 18 to 30 mass %, and more preferably from 18 to 25 mass %, in the HNBR from the viewpoints of achieving superior effects of an embodiment of the present invention and achieving excellent low-temperature performance (flexibility in low temperature conditions) and oil resistance.

In an embodiment of the present invention, the acrylonitrile amount of the HNBR can be measured in accordance with the semimicro Kjeldahl method based on JIS K 6384:2016.

### Hydrogenation Percentage

A hydrogenation percentage of the HNBR is preferably 95 to 100% of a double bond (present in a repeating unit derived from butadiene) of the NBR before hydrogenation from the viewpoint of achieving superior effects of an embodiment of the present invention.

In an embodiment of the present invention, the hydrogenation percentage of the HNBR can be measured in accordance with JIS K 6235:2006.

### Content of Hydrogenated Acrylonitrile Butadiene Rubber

In an embodiment of the present invention, the content of the hydrogenated acrylonitrile butadiene rubber is 60 mass % or more and 100 mass % or less in the rubber component (total amount) described above.

The content of the hydrogenated acrylonitrile butadiene rubber is preferably from 80 to 100 mass %, and more preferably 100 mass %, in the rubber component described above from the viewpoint of achieving superior effects of an embodiment of the present invention.

### Other Rubber Component

When the content of the hydrogenated acrylonitrile butadiene rubber is 60 mass % or more and less than 100 mass % in the rubber component described above, an additional rubber component that can be further contained in the rubber component is not particularly limited. Examples of such another rubber component include a butadiene rubber, a natural rubber (NR), an isoprene rubber (IR), an aromatic vinyl-conjugated diene copolymer rubber, a butyl rubber (IIR), a halogenated butyl rubber (Br—IIR, Cl—IIR), a chloroprene rubber (CR), an ethylene-propylene-diene rubber (EPDM), an ethylene-propylene rubber (EPM), chlorinated polyethylene rubber (CM), an acrylonitrile-butadiene rubber (NBR. Note that the NBR does not include a hydrogenated acrylonitrile butadiene rubber), and a chlorosulfonated polyethylene rubber (CSM).

### Content of Rubber Component

The content of the rubber component is preferably from 40 to 70 mass % in the total amount of the rubber composition of an embodiment of the present invention from the viewpoint of achieving superior effects of an embodiment of the present invention.

### Compound Represented by General Formula (1)

The rubber composition of an embodiment of the present invention contains a compound represented by General Formula (1) below.

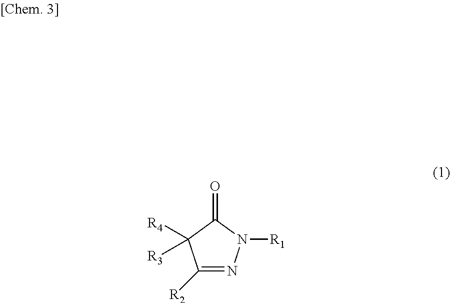

In General Formula (1), R₁, R₂, R₃, and R₄ are the same or different and each represent a hydrogen atom, an alkyl group, an aralkyl group, an aryl group, or a heterocyclic group. R₃ and R₄ may together form an alkylidene group, and any two of R₂, R₃, and R₄ may together form an alkylene group. Each of these groups may have one or more substituents.

R₁, R₂, R₃, and R₄

In General Formula (1), R₁, R₂, R₃, and R₄ are the same or different and each represent a hydrogen atom, an alkyl group, an aralkyl group, an aryl group, or a heterocyclic group. When R₁, R₂, R₃, and R₄ are hydrogen, the compound represented by General Formula (1) is 5-pyrazolone. In the present description, a compound having the skeleton of 5-pyrazolone may be referred to as a “pyrazolone derivative”.

### Alkyl Group

In the present description, examples of the “alkyl group” include linear, branched, or cyclic alkyl groups. Specific examples thereof include a linear or branched alkyl group having from 1 to 4 carbons, such as methyl, ethyl, n-propyl, isopropyl, n-butyl, isobutyl, s-butyl, t-butyl, and 1-ethylpropyl; a linear or branched alkyl group having from 1 to 18 carbons, including, in addition to the above linear or branched alkyl group having from 1 to 4 carbons, n-pentyl, isopentyl, neopentyl, n-hexyl, isohexyl, 3-methylpentyl, n-heptyl, n-octyl, n-nonyl, n-decyl, n-undecyl, n-dodecyl, 5-propylnonyl, n-tridecyl, n-tetradecyl, n-pentadecyl, hexadecyl, heptadecyl, and octadecyl; and a cyclic alkyl group having from 3 to 8 carbons, such as cyclopropyl, cyclobutyl, cyclopentyl, cyclohexyl, cycloheptyl, and cyclooctyl.

### Aralkyl Group

Examples of the “aralkyl group” include benzyl, phenethyl, trityl, 1-naphthylmethyl, 2-(1-naphthyl)ethyl, and 2-(2-naphthyl)ethyl groups.

### Aryl Group

Examples of the “aryl group” include phenyl, biphenyl, naphthyl, dihydroindenyl, and 9H-fluorenyl groups.

### Heterocyclic Group

Examples of the “heterocyclic group” include pyridyl, pyrimidyl, triazyl, quinolyl, isoquinolyl, quinoxalyl, cinnolyl, quinazolyl, phthalazyl, tetrahydroquinolyl, pyrrolyl, furyl, thienyl, imidazolyl, pyrazolyl, oxazolyl, thiazolyl, isoxazolyl, isothiazolyl, thiadiazolyl, oxadiazolyl, triazolyl, tetrazolyl, indolyl, isoindolyl, benzimidazolyl, benzofuranyl, isobenzofuranyl, benzothienyl, benzoxazolyl, benzothiazolyl, indazolyl, morpholyl, piperazyl, 2-piperazyl, piperidyl, tetrahydropyranyl, tetrahydrothiopyranyl, pyrrolidyl, furanyl, tetrahydrofuranyl, tetrahydrothienyl, and 5-methyl-3-oxo-2,3-dihydro-1H-pyrazol-4-yl groups.

### Alkylidene Group

Examples of the “alkylidene group” that may be formed by R₃ and R₄ together include methylidene, ethylidene, propylidene, isopropylidene, and butylidene groups.

### Alkylene Group

Examples of the “alkylene group” that may be formed by any two of R₂, R₃, and R₄ together include an ethylene group, a trimethylene group, a tetramethylene group, a pentamethylene group, a hexamethylene group, and a heptamethylene group. These alkylene groups may contain a nitrogen atom, an oxygen atom, and/or a sulfur atom and may contain a phenylene group.

### Substituent

Each of these alkyl groups, aralkyl groups, aryl groups, heterocyclic groups, alkylidene groups, and alkylene groups may include one or more substituents at a freely-chosen substitutable position. Examples of the “substituent” include a halogen atom, an amino group, an aminoalkyl group, an alkoxycarbonyl group, an acyl group, an acyloxy group, an amide group, a carboxyl group, a carboxyalkyl group, a formyl group, a nitrile group, a nitro group, an alkyl group, a hydroxyalkyl group, a hydroxy group, an alkoxy group, an aryl group, an aryloxy group, a heterocyclic group, a thiol group, an alkylthio group, and an arylthio group. Preferably from 1 to 5 substituents, and more preferably from 1 to 3 substituents, may be included.

### Aspect of Compound Represented by General Formula (1)

In General Formula (1), R₁, R₂, R₃, and R₄ are the same or different and each preferably are a hydrogen atom, a linear or branched alkyl group having from 1 to 4 carbons, an aralkyl group, an aryl group, or a heterocyclic group.

In General Formula (1), R₁ is preferably a hydrogen atom.

In General Formula (1), R₂ is preferably a hydrogen atom, a linear or branched alkyl group having from 1 to 4 carbons, an aralkyl group, an aryl group, or a heterocyclic group, more preferably a hydrogen atom, a linear or branched alkyl group having from 1 to 4 carbons, a benzyl group, a phenyl group, a naphthyl group, or a furyl group, and particularly preferably a hydrogen atom or a linear alkyl group having from 1 to 4 carbons.

General Formula (1) is preferably a compound in which at least one of R₃ or R₄ is a hydrogen atom, and more preferably a compound in which both of R₃ and R₄ are hydrogen atoms.

From the viewpoint of achieving superior effects of an embodiment of the present invention, the compound represented by General Formula (1) more preferably includes at least one type selected from the group consisting of a compound, in which R₁ is a hydrogen atom, R₂ is a hydrogen atom, a linear or branched alkyl group having from 1 to 4 carbons, an aralkyl group, an aryl group, or a heterocyclic group, and both R₃ and R₄ are hydrogen atoms, and a compound, in which R₁ is a hydrogen atom, R₂ is a hydrogen atom, a linear or branched alkyl group having from 1 to 4 carbons, an aralkyl group, an aryl group, or a heterocyclic group, and R₃ and R₄ form an alkylidene group together; and particularly preferably includes a compound, in which R₁ is a hydrogen atom, R₂ is a hydrogen atom or a linear alkyl group having from 1 to 4 carbons, and both R₃ and R₄ are hydrogen atoms.

Examples of the compound represented by General Formula (1) include 5-pyrazolone, 3-methyl-5-pyrazolone, 3-(naphthalen-2-yl)-1H-pyrazol-5 (4H)-one, 3-(furan-2-yl)-1H-pyrazol-5 (4H)-one, 3-phenyl-1H-pyrazol-5 (4H)-one, and 3-propyl-1H-pyrazol-5 (4H)-one.

Some compounds represented by General Formula (1) generate tautomers, and such tautomers are also included within the compounds represented by General Formula (1). Note that, when tautomerization can occur (e.g., in a solution), chemical equilibrium of the tautomers can be reached. In addition, the compound represented by General Formula (1) also includes salts thereof. Examples of the salts of the compound represented by General Formula (1) include inorganic acid salts, such as hydrochlorides, sulfates, and nitrates; organic acid salts, such as acetates and methanesulfonates; alkali metal salts, such as sodium salts and potassium salts; alkaline-earth metal salts, such as magnesium salts and calcium salts; and ammonium salts, such as dimethylammonium and triethylammonium.

### Content of Compound Represented by General Formula (1)

The content of the compound represented by General Formula (1) is preferably from 0.3 to 2.0 parts by mass, and more preferably from 0.5 to 2.0 parts by mass, per 100 parts by mass of the rubber component described above from the viewpoint of achieving superior effects of an embodiment of the present invention.

### Carbon Black

The rubber composition of an embodiment of the present invention contains carbon black.

### Nitrogen Adsorption Specific Surface Area

From the viewpoint of achieving superior effects of an embodiment of the present invention, the carbon black preferably contains one type or a plurality of types of carbon black having a nitrogen adsorption specific surface area (N₂SA) of less than 60 m²/g. The lower limit of the nitrogen adsorption specific surface area described above can be, for example, 20 m²/g or more.

In an embodiment of the present invention, the nitrogen adsorption specific surface area of the carbon black can be measured in accordance with JIS K 6217-2:2017.

Examples of the carbon black having the N₂SA of less than 60 m²/g include FEF carbon black, GPF carbon black, SRF carbon black, and FT carbon black.

From the viewpoint of achieving superior effects of an embodiment of the present invention, the carbon black preferably includes FEF carbon black and/or SRF carbon black.

### Content of Carbon Black

From the viewpoint of achieving superior effects of an embodiment of the present invention, the content of the carbon black (when two or more types of carbon blacks are used in combination, total amount thereof) is preferably from 40 to 150 parts by mass, and more preferably form 80 to 120 parts by mass, per 100 parts by mass of the hydrogenated acrylonitrile butadiene rubber described above.

When the carbon black contains FEF carbon black and SRF carbon black, the content of the FEF carbon black can be from 30 to 70 mass % in the total amount of the carbon black. The remainder excluding the FEF carbon black in the total amount of the carbon black can be a content of SRF carbon black.

### Peroxide

The rubber composition of an embodiment of the present invention contains a peroxide.

The peroxide contained in the rubber composition of an embodiment of the present invention is not particularly limited as long as it is a peroxide capable of extracting protons from HNBR.

Examples of the peroxide include benzoyl peroxide, dicumyl peroxide, di-t-butyl peroxide, t-butylcumyl peroxide, methyl ethyl ketone peroxide, cumene hydroperoxide, 2,5-dimethyl-2,5-di(t-butylperoxy) hexane, 2,5-dimethyl-2,5-di(benzoylperoxy) hexane, 1,3-bis(t-butylperoxypropyl)benzene, di(t-butylperoxyisopropyl)benzene, t-butylperoxybenzene, 2,4-dichlorobenzoylperoxide, and 1,1-dibutylperoxy-3,3,5-trimethylsiloxane.

From the viewpoints of being capable of functioning as a crosslinking agent and achieving superior effects of an embodiment of the present invention, the peroxide described above preferably includes an organic peroxide having a plurality of peroxy groups and more preferably includes at least one type selected from the group consisting of di-t-butylperoxide, 2,5-dimethyl-2,5-di(t-butylperoxy) hexane, 2,5-dimethyl-2,5-di(benzoylperoxy) hexane, 1,3-bis(t-butylperoxypropyl)benzene, and di(t-butylperoxyisopropyl)benzene.

### Content of Peroxide

From the viewpoint of achieving superior effects of an embodiment of the present invention, the content of the peroxide is preferably from 1.6 to 4.0 parts by mass, and more preferably from 2.3 to 3.0 parts by mass, per 100 parts by mass of the rubber component described above.

The peroxide used in the rubber composition of an embodiment of the present invention may be a mixture of a peroxide and silica. Examples of a commercially available product of the mixture of a peroxide and silica include Perkadox 14-40 (available from Kayaku Akzo Co., Ltd.).

When the mixture described above is used as a peroxide in the rubber composition of an embodiment of the present invention, the content of the peroxide contained in the rubber composition of an embodiment of the present invention refers to a net content of the peroxide in the mixture described above.

### Additive

The rubber composition according to an embodiment of the present invention can further contain additives, such as a crosslinking auxiliary (e.g., zinc oxide), an anti-aging agent, stearic acid, an antioxidant, a plasticizer, a co-crosslinking agent, an antistatic agent, a flame retardant, and silica, in a range that does not impair the object of the present invention. The additives are not particularly limited. Examples thereof include known additives. The content of each additive is not particularly limited and can be appropriately selected.

### Co-Crosslinking Agent

The co-crosslinking agent that can be further contained in the rubber composition of an embodiment of the present invention is not particularly limited as long as it is a compound that can crosslink HNBR. However, the co-crosslinking agent does not contain an organic peroxide having a plurality of peroxy groups. Examples of the co-crosslinking agent include triallyl isocyanurate and diallyl compounds.

When the rubber composition of an embodiment of the present invention further contains a co-crosslinking agent, the co-crosslinking agent preferably contains triallyl isocyanurate and/or a diallyl compound, and more preferably contains triallyl isocyanurate and a diallyl compound, from the viewpoint of achieving superior effects of an embodiment of the present invention.

### Triallyl Isocyanurate

The triallyl isocyanurate that can be contained in the rubber composition of an embodiment of the present invention is a compound having the following structure.

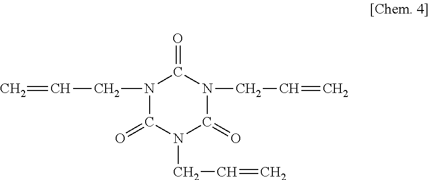 [SMILES: C=CCn1c(=O)n(CC=C)c(=O)n(CC=C)c1=O]

When the rubber composition of an embodiment of the present invention further contains triallyl isocyanurate, the content of triallyl isocyanurate is preferably 1.9 parts by mass or more, more preferably from 2.5 to 5.0 parts by mass, and even more preferably from 3.0 to 4.0 parts by mass, per 100 parts by mass of the hydrogenated acrylonitrile butadiene rubber described above from the viewpoint of achieving superior effects of an embodiment of the present invention.

### Diallyl Compound

The rubber composition of an embodiment of the present invention preferably further contains a diallyl compound from the viewpoint of achieving superior effects of an embodiment of the present invention.

The diallyl compound that may be contained in the rubber composition of an embodiment of the present invention is not particularly limited as long as the diallyl compound is a compound having two allyl groups. Examples thereof include aromatic compounds having two allyl groups such as diallyl phthalate.

From the viewpoint of achieving superior effects of an embodiment of the present invention, the diallyl compound preferably includes diallyl phthalate.

When the rubber composition of an embodiment of the present invention further contains a diallyl compound, the content of the diallyl compound is preferably from 3.0 to 20 parts by mass, more preferably from 5.0 to 10.0 parts by mass, and even more preferably from 7.0 to 10.0 parts by mass, per 100 parts by mass of the hydrogenated acrylonitrile butadiene rubber described above from the viewpoint of achieving superior effects of an embodiment of the present invention.

### Silica

The rubber composition of an embodiment of the present invention can further contain silica.

When the rubber composition of an embodiment of the present invention further contains silica, examples of the silica that can be further contained in the rubber composition of an embodiment of the present invention include silica derived from a mixture of a peroxide and silica when the peroxide described above is the aforementioned mixture, and silica added to the rubber composition of an embodiment of the present invention as silica alone (excluding the silica derived from a mixture of a peroxide and silica when the peroxide is the aforementioned mixture, and hereinafter, the same applies to silica alone).

Silica in the mixture described above or silica as the silica alone described above is not particularly limited.

In the rubber composition of an embodiment of the present invention, the content of silica (e.g., when the peroxide is a mixture of a peroxide and silica, the content of silica derived from the mixture, the content of silica as silica alone, or the total amount thereof, and hereinafter, the same applies to the content of silica) can be from 0 to 10 parts by mass per 100 parts by mass of the hydrogenated acrylonitrile butadiene rubber described above.

The rubber composition according to an embodiment of the present invention can be a rubber composition containing substantially no sulfur. The rubber composition of an embodiment of the present invention containing substantially no sulfur means the amount of the sulfur being from 0 to 0.5 mass % in the total amount of the rubber composition of an embodiment of the present invention.

The rubber composition of an embodiment of the present invention can be a rubber composition containing substantially no foaming agent.

The foaming agent refers to a compound that can make the resulting cured article foamed.

The foaming agent is not particularly limited. Examples thereof include organic chemical foaming agents including organic acids and metal salts thereof, such as azodicarbonamide, N,N′-dinitrosopentanemethylenetetramine, p,p′-oxybis(benzenesulfonyl hydrazide), p-toluenesulfonyl hydrazide, p-toluenesulfonyl semicarbazide, diazoaminobenzene, hydrazodicarbonamide, barium azodicarboxylate, azobisisobutyronitrile, and monosodium citrate; and inorganic chemical foaming agents, such as sodium bicarbonate, ammonium hydrogen carbonate, sodium carbonate, ammonium carbonate, aluminum acetate, ammonium nitrite, and borohydride sodium.

The rubber composition of an embodiment of the present invention containing substantially no foaming agent means the amount of the foaming agent being from 0 to 5 parts by mass per 100 parts by mass of the compound represented by General Formula (1) above.

In an example of a preferable aspect, the composition of an embodiment of the present invention contains substantially no magnesium oxide.

The rubber composition of an embodiment of the present invention containing substantially no magnesium oxide means the amount of the magnesium oxide being from 0 to 3 parts by mass per 100 parts by mass of the rubber component described above.

### Production Method

The production of the rubber composition of an embodiment of the present invention is not particularly limited. Examples of the production method include a method for producing the rubber composition of an embodiment of the present invention by mixing the HNBR, the compound represented by General Formula (1), the carbon black, and the peroxide (the peroxide may be a mixture of peroxide and silica), as well as optionally used additives described above under a condition of 40 to 200° C. using a closed mixer, such as a Banbury mixer or a kneader, or a kneading roll mill.

The condition for crosslinking the rubber composition of an embodiment of the present invention is not particularly limited. For example, the rubber composition of an embodiment of the present invention can be crosslinked while a pressure is applied in a condition at 140 to 160° C.

### For Hose

The rubber composition of an embodiment of the present invention can be used as a rubber composition for a hose. In particular, in an example of a preferable aspect, the rubber composition of an embodiment of the present invention is used for an inner tube (innermost layer) of a hose.

Examples of the hose described above include a hose for an automobile, and specific examples thereof include a power steering hose for an automobile (a hose used in a power steering system).

### Power Steering Hose

The power steering hose of an embodiment of the present invention is a power steering hose produced by using the rubber composition of an embodiment of the present invention.

The rubber composition used in the power steering hose of an embodiment of the present invention is not particularly limited as long as it is the rubber composition of an embodiment of the present invention.

In an example of a preferable aspect, the power steering hose of an embodiment of the present invention includes an inner tube, a reinforcing layer, and an outer tube as constituent members. The power steering hose of an embodiment of the present invention may further include an intermediate rubber layer as a constituent member.

In the power steering hose of an embodiment of the present invention, whether the rubber composition of an embodiment of the present invention is applied to the constituent member of the power steering hose of an embodiment of the present invention is not particularly limited. However, from the viewpoint of a cured article produced by using the rubber composition of an embodiment of the present invention achieving elongation at break and modulus in a compatible manner at an excellent level, in an example of a preferable aspect, the power steering hose of an embodiment of the present invention includes an inner tube made by using the rubber composition described above.

An example of the power steering hose of an embodiment of the present invention is described with reference to the accompanying drawing. The present invention is not limited to the accompanying drawing.

The drawing is a schematic perspective view illustrating an example of a power steering hose of an embodiment of the present invention with layers partially cut away.

In the drawing, a power steering hose 10 includes an inner tube 12, an intermediate rubber layer 14, and an outer tube 16, includes a reinforcing layer 18 between the inner tube 12 and the intermediate rubber layer 14, and includes a reinforcing layer 20 between the intermediate rubber layer 14 and the outer tube 16.

The inner tube 12 which is the innermost layer of the power steering hose 10 is preferably formed of at least the rubber composition of an embodiment of the present invention.

In the power steering hose of an embodiment of the present invention, a thickness of the inner tube can be, for example, approximately from 0.5 to 5.0 mm, and is preferably from 0.8 to 3.0 mm.

The power steering hose of an embodiment of the present invention may include a reinforcing layer. The case where the power steering hose of an embodiment of the present invention includes a reinforcing layer is preferred because tensile strength at break, usable pressure range, and sealing properties by swaging (metal mountability) of the hose are improved. Examples of the reinforcing layer include structures in a blade form, helical form, net form, or film form. Examples of the material of the reinforcing layer include organic yarns (reinforcing yarns) such as aramid fibers, nylon, rayon, vinylon, and polyester; and metal wires such as brass-plated or zinc-plated steel wires.

In the power steering hose of an embodiment of the present invention, examples of a material that can form the outer tube (outermost layer) include a rubber composition containing a butyl rubber, a halogenated butyl rubber, an ethylene propylene rubber, a brominated isobutylene-p-methylstyrene copolymer rubber (BIMS), and an ethylene-acrylic acid ester copolymer rubber (AEM).

The thickness of the outer tube is, for example, preferably from 0.5 to 5.0 mm, and more preferably from 0.8 to 3.0 mm.

The power steering hose of an embodiment of the present invention may optionally include an intermediate rubber layer. When the power steering hose of an embodiment of the present invention includes the intermediate rubber layer, the material of the intermediate rubber layer is not particularly limited as long as it is, for example, a rubber composition excellent in adhesion to the reinforcing layer described above.

The thickness of the intermediate rubber layer can be, for example, from 0.1 to 3 mm.

### Method for Producing Power Steering Hose of Present Invention

Examples of the method for producing the power steering hose of an embodiment of the present invention include a method, in which the rubber composition of an embodiment of the present invention in an unvulcanized state is disposed in a cylindrical form on a periphery of a mandrel or the like, a reinforcing layer is disposed on the periphery thereof, a rubber composition for an intermediate rubber layer is further disposed in a cylindrical form on the periphery thereof, a reinforcing layer is disposed on the periphery thereof, a rubber composition for an outer tube is further disposed in a cylindrical form on the periphery thereof, and then the entire power steering hose is heated. The heating temperature is preferably 120° C. or higher, and more preferably from 140 to 170° C. After adequate cooling after heating, by removing from the mandrel, the power steering hose of an embodiment of the present invention can be produced.

The fluid passed through the inner portion of the power steering hose of an embodiment of the present invention is not particularly limited. Examples of the fluid include a fluid containing an oil having an aniline point of 90° C. or higher. In an example of a preferable aspect, a fluid contains an oil having an aniline point of 105° C. or higher.

### EXAMPLES

The present invention is described in further detail below using examples.

Materials, used amounts, proportions, treatment details, treatment procedure, and the like described in the following examples can be appropriately modified without departing from the gist of the present invention. Thus, the scope of the present invention is not limited to the following examples.

### Production of Rubber Composition

Each of the components listed in Tables 1 and 2 below were used in compositions (parts by mass) listed in the same table and mixed by an agitator, and thus each rubber composition was produced.

Note that, in the column of peroxide (14-40) in Tables 1 and 2, a numerical value in an upper row^{*1} represents a total amount of a commercially available product used as peroxide, and a numerical value in parentheses in a lower row^{*2} represents a net amount of peroxide in the commercially available product. The aforementioned commercially available products are described below.

### Crosslinking

Each rubber composition prepared as described above was subjected to press crosslinking for 90 minutes under conditions of 160° C. using a press molding machine (surface pressure: 3.0 MPa) to produce a crosslinked sheet (2 mm thick) as a cured article.

### Evaluation

The following evaluations were performed using the vulcanized sheet produced as described above. The results are listed in Tables 1 and 2.

### Tensile Property

A dumbbell-shaped JIS No. 3 test piece was punched out from each crosslinked sheet produced as described above, and the tensile properties were evaluated for the resulting test piece.

### Tensile Test

Using each test piece produced as described above, a tensile test was performed in accordance with JIS K 6251:2017 under conditions of 23° C.±2° C. at a tensile speed of 500 mm/min, and elongation at break (EB; unit: %) and 50% modulus (M50; unit: MPa) were measured.

Evaluation Criteria for Balance between Elongation at Break and Modulus

In an embodiment of the present invention, a case where the EB described above is 135% or more, the M50 described above is 3.0 MPa or more, and a value calculated by multiplying the EB and the M50 (the value is also referred to as “M50*EB”. hereinafter the same) is larger than M50*EB of a case where no compound represented by General Formula (1) is contained is evaluated as achieving elongation at break and modulus in a compatible manner at an excellent level.

As described above, when the EB described above is 135% or more, the M50 described above is 3.0 MPa or more, and the M50*EB is larger than M50*EB of a case where no compound represented by General Formula (1) is contained, a larger M50*EB in an embodiment of the present invention is preferred because elongation at break and modulus can be achieved in a compatible manner at an excellent level.

Note that a case where the EB described above is 135% or more is preferred because toughness against internal pressure is excellent. A larger value of the EB described above more than 135% indicates superior toughness against internal pressure.

A case where the M50 described above is 3.0 MPa or more is preferred because sealing properties with the metal parts are excellent. A larger value of the M50 described above more than 3.0 MPa indicates superior sealing properties with the metal parts.

### TR-10

### Low Temperature Elasticity Recovery Test

By using each of the crosslinked sheet produced as described above, a low temperature elasticity recovery test was performed in accordance with ASTM D 1329, and a temperature (TR-10) at which the elongation of each sample was recovered by 10% was measured.

### Evaluation Criteria

A case where the result of the low temperature elasticity recovery test is −25° C. or lower is preferred because low-temperature performance (flexibility in low temperature conditions) is excellent.

In the case described above, a lower result of the low temperature elasticity recovery test indicates superior low-temperature performance.

TABLE 1

| Table 1-1 | | | | | | | | |
|---|---|---|---|---|---|---|---|---|
| (HNBR 1 was | Comparative | Comparative | Example | Example | Example | Example | Comparative | Example |
| blended) | Example 1 | Example 2 | 1 | 2 | 3 | 4 | Example 3 | 5 |
| HNBR 1 | 100.0 | 100.0 | 100.0 | 100.0 | 100.0 | 100.0 | 100.0 | 100.0 |
| (LT2007 AN 21%) | | | | | | | | |
| FEF | 40.0 | 40.0 | 40.0 | 40.0 | 40.0 | 40.0 | 40.0 | 40.0 |
| SRF | 50.0 | 50.0 | 50.0 | 50.0 | 50.0 | 50.0 | 50.0 | 50.0 |
| Magnesium oxide | | | | | | | | |
| Zinc oxide | 2.0 | 2.0 | 2.0 | 2.0 | 2.0 | 2.0 | 2.0 | 2.0 |
| Anti-aging agent | 1.5 | 1.5 | 1.5 | 1.5 | 1.5 | 1.5 | 1.5 | 1.5 |
| Stearic acid | 1.0 | 1.0 | 1.0 | 1.0 | 1.0 | 1.0 | 1.0 | 1.0 |
| Pyrazolone derivative | | | 0.3 | 0.6 | 1.2 | 2.0 | | 0.6 |
| Plasticizer (TP-95) | | | | | | | | |
| Co-crosslinking agent | 3.5 | 3.5 | 3.5 | 3.5 | 3.5 | 3.5 | 3.5 | 3.5 |
| 1 (TAIC pure product) | | | | | | | | |
| Co-crosslinking agent | 8.0 | 8.0 | 8.0 | 8.0 | 8.0 | 8.0 | 8.0 | 8.0 |
| 2 (DAP) | | | | | | | | |
| Peroxide (14-40) | 3.0 | 5.0 | 5.0 | 5.0 | 5.0 | 5.0 | 5.5 | 5.5 |
| upper row*¹ | (1.2) | (2.0) | (2.0) | (2.0) | (2.0) | (2.0) | (2.2) | (2.2) |
| (lower row*²) | | | | | | | | |
| EB (%) | 290 | 180 | 200 | 230 | 250 | 300 | 155 | 200 |
| M50 (MPa) | 2.2 | 4.2 | 4.1 | 4.0 | 3.9 | 3.6 | 5.1 | 4.6 |
| M50*EB | 635 | 756 | 819 | 915 | 963 | 1080 | 789 | 918 |
| TR-10 (° C.) | −31 | −30 | −30 | −30 | −30 | −30 | −30 | −30 |

TABLE 2

| Table 1-2 | Comparative | | Comparative | | |
|---|---|---|---|---|---|
| (HNBR 1 was blended) | Example 4 | Example 6 | Example 5 | Example 7 | Example 9 |
| HNBR 1 | 100.0 | 100.0 | 100.0 | 100.0 | 100.0 |
| (LT2007 AN 21%) | | | | | |
| FEF | 40.0 | 40.0 | 90.0 | 90.0 | 40.0 |
| SRF | 50.0 | 50.0 | | | 50.0 |
| Magnesium oxide | | | | | 10.0 |
| Zinc oxide | 2.0 | 2.0 | 2.0 | 2.0 | 2.0 |
| Anti-aging agent | 1.5 | 1.5 | 1.5 | 1.5 | 1.5 |
| Stearic acid | 1.0 | 1.0 | 1.0 | 1.0 | 1.0 |
| Pyrazolone derivative | | 0.6 | | 0.6 | 0.6 |
| Plasticizer (TP-95) | | | | | |
| Co-crosslinking agent 1 | 3.5 | 3.5 | 3.5 | 3.5 | 3.5 |
| (TAIC pure product) | | | | | |
| Co-crosslinking agent 2 | 8.0 | 8.0 | 8.0 | 8.0 | 8.0 |
| (DAP) | | | | | |
| Peroxide (14-40) | | | | | |
| upper row*¹ | 6.0 | 6.0 | 6.0 | 6.0 | 6.0 |
| (lower row*²) | (2.4) | (2.4) | (2.4) | (2.4) | (2.4) |
| EB (%) | 140 | 190 | 110 | 150 | 180 |
| M50 (MPa) | 6.0 | 5.3 | 6.7 | 6.0 | 5.8 |
| M50*EB | 834 | 1003 | 737 | 900 | 1048 |
| TR-10 (° C.) | −30 | −30 | −28 | −28 | −30 |

TABLE 3

| | Comparative | | Comparative | |
|---|---|---|---|---|
| Table 2 (HNBR 2 was blended) | Example 6 | Example 8 | Example 7 | Example 10 |
| HNBR 2 | 100.0 | 100.0 | 100.0 | 100.0 |
| (Zetpol 2000L AN 36%) | | | | |
| FEF | 90.0 | 90.0 | 40.0 | 40.0 |
| SRF | | | 50.0 | 50.0 |
| Magnesium oxide | 10.0 | 10.0 | | |
| Zinc oxide | | | 2.0 | 2.0 |
| Anti-aging agent | 1.5 | 1.5 | 1.5 | 1.5 |
| Stearic acid | 1.0 | 1.0 | 1.0 | 1.0 |
| Pyrazolone derivative | | 0.6 | | 0.6 |
| Plasticizer (TP-95) | 7.0 | 7.0 | | |
| Co-crosslinking agent 1 (TAIC pure | 3.5 | 3.5 | 3.5 | 3.5 |
| product) | | | | |
| Co-crosslinking agent 2 (DAP) | | | 8.0 | 8.0 |
| Peroxide (14-40) | | | | |
| upper row*¹ | 10.0 | 10.0 | 6.0 | 6.0 |
| (lower row*²) | (4.0) | (4.0) | (2.4) | (2.4) |
| EB (%) | 130 | 140 | 158 | 214 |
| M50 (MPa) | 8.0 | 7.5 | 6.3 | 5.6 |
| M50*EB | 1039 | 1046 | 993 | 1194 |
| TR-10 (° C.) | −19 | −19 | −20 | −20 |

Details of each of the components listed in Tables 1 and 2 are as follows.

### HNBR

HNBR 1 (LT2007 AN 21%): Hydrogenated acrylonitrile butadiene rubber. Trade name: THERBAN LT 2007, available from ARLANXEO. AN content: 21 mass %, hydrogenation percentage: 99%
HNBR 2 (Zetpol 2000L, AN 36%): Hydrogenated acrylonitrile butadiene rubber. Trade name: ZETPOL 2000L, available from Zeon Corporation. AN content: 36 mass %, hydrogenation percentage: 99%

### Carbon Black

FEF: FEF carbon black (available from Nippon Steel Carbon Co., Ltd.); nitrogen adsorption specific surface area: 41 m²/g
SRF: SRF carbon black (trade name: Niteron #S, available from NSCC Carbon Co., Ltd.); nitrogen adsorption specific surface area: 25 m²/g
Magnesium oxide: Kyowamag 150, available from Kyowa Chemical Industry Co., Ltd.
Zinc oxide: Zinc Oxide III, available from Seido Chemical Industry Co., Ltd.
Anti-aging agent: 2-Mercaptobenzimidazole. NOCRAC MBZ, available from Ouchi Shinko Chemical Industrial Co., Ltd.
Stearic acid: Lunac YA, available from Kao Corporation

### Compound Represented by General Formula (1)·

Pyrazolone derivative: 3-Methyl-5-pyrazolone (the following structure). Trade name: EN-01, available from Otsuka Chemical Co., Ltd.

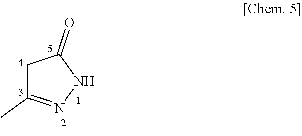

Plasticizer (TP-95): Bis [2-2 (butoxyethoxy)ethyl] adipate. Trade name: TP-95, available from The Hallstar Company.
Co-crosslinking agent 1 (TAIC pure product): Triallyl isocyanurate. Trade name: TAIC, available from Nihon Kasei Co., Ltd.
Co-crosslinking agent 2 (DAP): Diallyl phthalate, available from Daiso Co., Ltd.

### Peroxide

Peroxide (14-40): Perkadox 14-40 (trade name), available from Kayaku Akzo Corporation. The commercially available product described above is a mixture of di(t-butylperoxyisopropyl)benzene and silica, and in the commercially available product, the content of di(t-butylperoxyisopropyl)benzene is 40 mass %, and the content of silica is 60 mass %. Di(t-butylperoxyisopropyl)benzene can also function as a crosslinking agent.

### Evaluation Result

The results of Tables 1 and 2 show that the rubber composition of an embodiment of the present invention achieved the desired effects.

On the other hand, Comparative Example 1 which did not contain the compound represented by General Formula (1) had unsatisfactory M50.

Comparative Example 2 which did not contain the compound represented by General Formula (1) had a lower M50*EB than those of Examples 1 to 4. The results of M50*EB for Comparative Example 3 compared with Example 5, Comparative Example 4 compared with Example 6, Comparative Example 5 compared with Example 7, and Comparative Example 6 compared with Example 8 were the same and/or similar to the result described above. Comparative Examples 5 and 6 also had unsatisfactory EB.

### REFERENCE SIGNS LIST

10 Power steering hose
12 Inner tube
14 Intermediate rubber layer
16 Outer tube
18, 20 Reinforcing layer

1. A rubber composition comprising:
a rubber component containing 60 mass % or more of a hydrogenated acrylonitrile butadiene rubber;
a compound represented by General Formula (1);
carbon black; and
a peroxide: 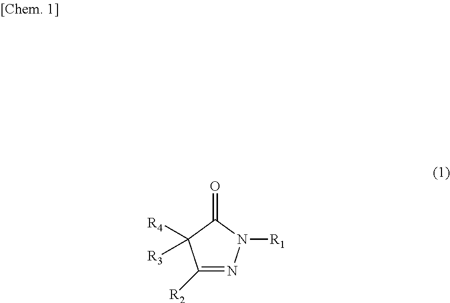
where
R₁, R₂, R₃, and R₄ are the same or different and represent a hydrogen atom, an alkyl group, an aralkyl group, an aryl group, or a heterocyclic group, R₃ and R₄ may together form an alkylidene group, and any two of R₂, R₃, and R₄ may together form an alkylene group, and each of these groups may have one or more substituents.

2. The rubber composition according to claim 1, wherein a content of the compound represented by General Formula (1) is from 0.3 to 2.0 parts by mass per 100 parts by mass of the rubber component.

3. The rubber composition according to claim 1, wherein the carbon black include one type or a plurality of types of carbon black having a nitrogen adsorption specific surface area of less than 60 m²/g.

4. The rubber composition according to claim 1, wherein a content of the peroxide is from 1.6 to 4.0 parts by mass per 100 parts by mass of the rubber component.

5. The rubber composition according to claim 1, wherein substantially no sulfur is contained.

6. The rubber composition according to claim 1, wherein the rubber composition is for a hose.

7. A power steering hose produced by using the rubber composition according to claim 1.

8. The power steering hose according to claim 7, comprising an inner tube containing the rubber composition.
